(19) United States
(12) Patent Application Publication
(10) Pub. No.: US 2008/0162206 A1
(43) Pub. Date: Jul. 3, 2008

(54) Rich media engagement market targeting

(75) Inventors: Jarvis C. Mak, Bellevue, WA (US); Valter Sciarrillo, San Francisco, CA (US); Kelli M. Nardis, Menlo Park, CA (US); Hunter Madsen, Toronto (CA)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/647,965

(22) Filed: Dec. 28, 2006

(51) Int. Cl. G06Q 10/00

(52) U.S. Cl. 705/7

(57) ABSTRACT

Targeting potential consumers for marketing purposes involves receiving an indication that a particular user interacted with a particular rich media advertisement in a particular manner. The ability to monitor more user interactions with an advertisement, such as a mouseover of a certain panel of a rich media advertisement, provides for better differentiation among users' interactions with advertisements and more information about a user's behavior generally. An association between the interaction and user profile information is stored, where the profile information is about the particular user other than that user's interactions with the rich media advertisement. Consequently, important information that is useful for behavioral targeting is generated and compiled without having to follow the user to websites from links within advertisements. Furthermore, recommendations about marketing to the particular user can be provided to advertisers, as well as information regarding further use of the rich media advertisement.

### FIELD OF THE INVENTION

The present invention relates generally to management of market targeting information and, more specifically, to associating a rich media action with an identifiable consumer.

### BACKGROUND OF THE INVENTION

In a commercial context, the World Wide Web (referred to herein simply as the “web”) is used to a large extent to market goods and services to the consuming public. A large portion of the publicly available web content is offered free of charge, however, many sites display various forms of paid advertisement in conjunction with serving free content. Intuitively, the more focused that a group being marketed to is, the more focused advertisements can and should be for marketing to that group, and the more effective such advertising is expected to be. Hence, target marketing is an important aspect of the current incarnation of the web, with a general goal of serving focused advertisements to a certain group of consumers believed to be likely consumers of certain goods and services to which the corresponding advertisements apply.

Historically, interactions with online advertisements have been measured solely by “click-throughs” (also referred to as ad clicks or requests), which refers to the process of a user clicking on a web advertisement and going to the advertiser's website. However, measuring click-throughs is a binary type of metric, i.e., either the user clicks on the ad or does not click on the ad, which provides only limited insight to a user's interests and web surfing habits. Because more comprehensive information is desired about what the user does when going to the advertiser's website, some websites have been instrumented to monitor the user's navigation and actions within the advertiser's website, such as through the use of web beacons. However, there are often privacy and legal issues involved with tracking a user from one site to another site and tracking a user within multiple sites, which significantly complicates such an approach to obtaining information about users' web surfing behavior.

In view of the foregoing, there is a need for more comprehensive approaches to obtaining information about users of the web for market targeting purposes.

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a functional operating environment, according to an embodiment of the invention;

FIG. 2 is a flow diagram that illustrates a method for rich media engagement based market segmentation, according to an embodiment of the invention; and

FIG. 3 is a block diagram that illustrates a computer system upon which an embodiment of the invention may be implemented.

### DETAILED DESCRIPTION OF EMBODIMENTS OF THE INVENTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Definitions

The following definitions apply to terminology used herein.

“Target Marketing” refers to a process of breaking a market into segments and then concentrating marketing efforts on one or more key segments. “Market segmentation” and “market targeting” refer to the process of breaking a market into segments. A “target market” is the market segment to which a particular product is marketed and comprises a group of individuals whom, collectively, are intended recipients of an advertiser's message.

“Rich media” refers to a broad range of interactive digital media that exhibit dynamic motion, taking advantage of enhanced sensory features such as video, audio, and moving animation. This term is used to describe widely varying technologies and implementations. When online advertising is described as “rich media” it generally is understood to mean any creative unit that exhibits dynamic motion, which may occur over time or in direct response to user interaction with the rich media. Rich media is generally used to attract a viewer's attention and, in many cases, to entice the viewer to interact with the rich media. For non-limiting examples, rich media may offer a video and/or dynamic animation for viewing, an interactive game for playing, a text entry box for entering text, and the like.

A “mouseover” refers to a particular user interaction with a displayed object, where the user locates a cursor over the object without necessarily clicking on the object. Further, a mouseover typically triggers a change to what is displayed, for example, by causing an expanded rendering of the object or display of an image or a hyperlink over the web page when the cursor passes over the object.

A “web portal” (or simply a “portal”) refers to a website or network that offers a broad array of resources and services, for non-limiting examples: e-mail, discussion forums, newsgroups, news, content feeds, a search engine, on-line shopping and other vertical aggregates, and the like.

### Functional Overview of Embodiments

Target marketing is an important aspect of the web, with a general goal of serving focused advertisements to a certain group of consumers believed to be likely consumers of certain goods and services to which the corresponding advertisements apply. Therefore, the more information about consumers that can be collected and correlated, such as demographics, personal interests, online behavior, and the like, the more accurately consumers can be grouped for marketing purposes and the more focused a given marketing campaign can be. Because rich media is an engaging medium, and entices user interaction, rich media is a valuable source of information about potential consumers. With rich media, the spectrum broadens regarding the granularity and amount of information that can be collected about a user's engagement with such rich media.

A technique described herein for targeting potential consumers for marketing purposes generally involves the collection, correlation, and analysis of users' interactions with rich media in conjunction with users' use of the web outside of the rich media content. Such an approach involves receiving an indication that a particular user interacted with a particular rich media advertisement in a particular manner. For non-limiting examples, an indication may be received that the user performed a mouseover on a particular frame of the rich media advertisement, that the user selected playing of a video associated with the rich media advertisement, that the user viewed the video for a certain length of time before selecting pause, that the user performed a particular action with an animated character a certain number of times, and the like. The ability to monitor more user interactions with an advertisement, such as a mouseover of a certain panel of a rich media advertisement, provides for better differentiation among users and more information about users' behavior generally.

An association between the rich media interaction and user personal profile information is stored, where the personal profile information is about the particular user other than that user's interactions with the rich media advertisement. For example, a website or web portal may require some personal information when registering for an account with the site or portal and, therefore, demographic information about the user can be associated with information about the user's interaction with the rich media. For another example, a website or web portal may track a user's navigation throughout the site or portal, including the user's search activities. Therefore, information about the user's interests and web surfing behavior (e.g., historical behavior and/or recent behavior) can be associated with information about the user's interaction with the rich media.

Consequently, important information that is useful for behavioral market targeting, for example, is generated and compiled without having to follow the user to websites from links within rich media advertisements. Thus, information about the particular user's interaction with the rich media advertisement and the user's profile is provided for grouping the particular user into a particular target market group. Furthermore, recommendations about marketing to the particular user can be provided to advertisers, as well as information regarding further use of the rich media advertisement.

### Functional Operating Environment

Advertisers want to be able to learn about and target consumers that show various levels of interaction with rich media advertisement units. In most cases, those interactions are identified by a mouseover rather than a click. Some consumers might never click on an advertisement but do not mind mousing over in order to explore the advertisement. For advertisers, by knowing which users engage with their advertisements and in what ways, they can measure product interest and creative elements of the advertisement in a much more granular fashion than could be done previously through ad clicks alone. Thus, techniques described herein associate a rich media action (e.g., a mouseover) to an identifiable consumer on a web portal network, allowing for analytical and market segmentation capabilities.

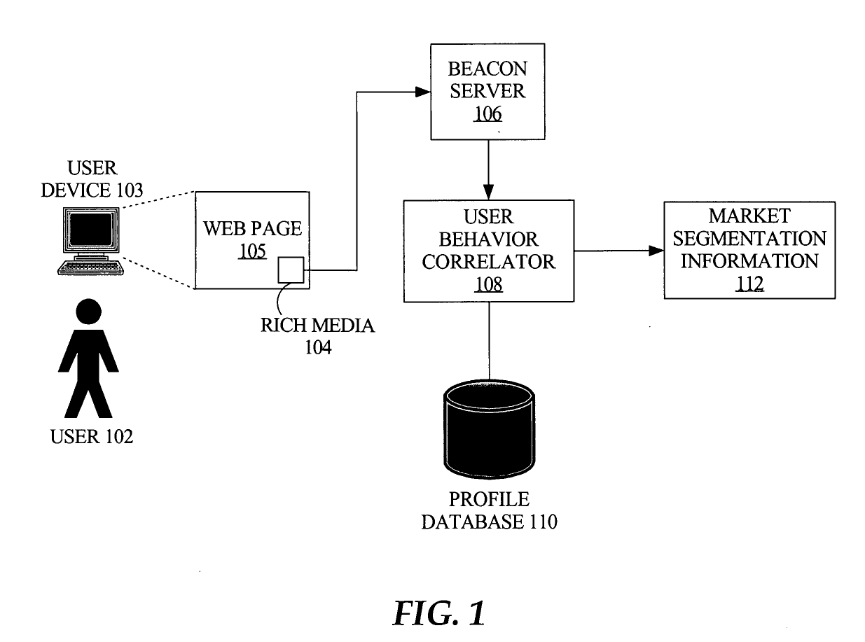

FIG. 1 is a block diagram that illustrates a functional operating environment, according to an embodiment of the invention. FIG. 1 depicts a user 102 at a user device 103, rich media 104 presented within a web page 105, a beacon server 106, a user behavior correlator 108, a profile database 110, and market segmentation information 112.

User 102 represents a user that is navigating the World Wide Web from a user device 103, e.g., via a web browser. User device 103 can be any type of device that is capable of communicative coupling to and communication with other devices via the web, either by wire or in a wireless manner. Non-limiting examples of user device 103 include a desktop or laptop computer, a personal digital assistant, a cell phone, a wireless handheld device, or any combination of the same. As user 102 navigates the web, a web page 105 is rendered on the user's browser and the web page 105 contains rich media 104.

The HTML code underlying web page 105 contains an embedded link to rich media 104, e.g., through use of an HTML “href” attribute that specifies the resource location of rich media 104. The rich media 104 may be served by the same party that serves web page 105 or rich media 104 may be served by a different party than the party that servers web page 105. Regardless of what party serves rich media 104, the rich media 104 is instrumented to notify beacon server 106 when the user interacts with the rich media 104 in a certain manner. For example, different panels or frames, and different features of rich media 104 such as the “Play”, “Pause”, and “Stop” buttons for a video presentation, may be independently instrumented to notify beacon server 106 of a user interaction with that corresponding panel, frame, or feature.

Instrumentation of Rich Media

According to one embodiment, one or more aspects of rich media 104, for which a party wants to be notified of a corresponding user interaction therewith, are instrumented with a web beacon (also referred to simply as a “beacon” or a “pixel tag”). Beacons are used in combination with cookies, which are messages initially given to a web browser by a web server, stored by the browser, and sent back to the server each time the browser requests a page from the server. Cookies are primarily used to identify corresponding users and to exchange information about the users. Used in combination with cookies, a beacon is an often-transparent graphic image, usually no larger than 1 pixel×1 pixel, that is placed on a website to monitor the behavior of the user visiting the website. When a web browser sends a request to a server (e.g., beacon server 106) to retrieve the image, the browser passes along to the server information associated with the requesting user session, such as the IP address of the device that retrieved the image, the time at which the beacon was viewed and for how long, the type of browser that retrieved the image, and previously set cookie values. Hence, through the mechanisms of beacons and cookies, any panel, frame, feature, or attribute of rich media 104 can be instrumented to send a message to a beacon server 106 to identify a user and the user's particular interaction with the corresponding panel/frame, feature, or attribute. In some scenarios, such a message may be sent to beacon server 106 via a web server. For example, in a scenario in which the “Play” button for a video presentation is beaconed, when a user clicks on the button a request is sent to a web server that serves the video, and at least a portion of the request (i.e., the cookie and an indication of what particular user interaction the request is in response to) is forwarded to beacon server 106.

According to an embodiment, a beacon is included in the code for rich media 104 so that in response to a mouseover of rich media 104, beacon server 106 is notified that a particular identified or identifiable user moused over rich media 104. Similarly, according to an embodiment, a beacon is included in the code for rich media 104 so that in response to a mouseover of a particular rich media 104 component (e.g., panel, frame, feature, or attribute), beacon server 106 is notified that a particular identified or identifiable user moused over the rich media 104 component. For example, a rich media 104 may be configured with three different panels, where each panel is independently beaconed to notify beacon server 106 when a user mouses over any of the three panels and which specific panel was moused over. For example, a rich media associated with a banking institute may contain a first panel regarding a credit card offer, a second panel regarding a brokerage product, and a third panel regarding a mortgage product. Thus, beaconing each panel provides for knowing specifically which panel, and therefore which bank offering, in which the user was interested. Further, users that moused over all three panels, moused over some of the panels multiple times, or moused over some combination of the panels, can be reported on and targeted for marketing purposes.

The manner in which rich media 104 is instrumented to send to beacon server 106 an indication that a user interacted with the rich media 104 may vary from implementation to implementation. Therefore, embodiments of the invention are not limited to use of beacons only or limited to monitoring mouseovers only. Rather, any type of user interaction with rich media 104 may be monitored and measured, and a more complex tracking mechanism than a beacon may be used. For example, one may want to track when users click on the “Play”, “Pause”, and “Stop” buttons for a video presentation, and measure the time elapsed between such operations, in order to know how long and how many times a user views the video. Thus, each of the buttons may be instrumented (e.g., with a beacon or similar functionality) and the beacon server 106 can compute and track various metrics associated with the user rich media interactions corresponding to the respective beacons, such as time between interactions, number of interactions, preceding and succeeding interactions, and other metrics involving the user's scope and duration of engagement with the rich media 104.

User Behavior Correlation for Market Segmentation

If and when user 102 interacts with a beaconed, or otherwise monitored, component of rich media 104, beacon server 106 receives a message from the user's web browser. As described, from this message the beacon server 106 is able to identify the particular user 102 in some form, e.g., by the user's personal login ID or by the IP address of user device 103, and associate the particular user interaction and the particular component of rich media 104 with the particular user 102. Beacon server 106 transmits such information to a user behavior correlator 108, e.g., in the form of the original message or in the form of a string of data representing the pertinent data: user identifier, rich media component, user interaction. The manner in which user behavior correlator 108 and beacon server 106 are configured may vary from implementation to implementation. For example, user behavior correlator 108 may be configured as a component of beacon server 106 or may be configured separately from beacon server 106.

Regardless of the particular configuration and interrelation of user behavior correlator 108 and beacon server 106, user behavior correlator 108 has access to a profile database 110. Profile database 110 stores user profile information. For example, a website or web portal may require some personal demographic information when registering for an account with the site or portal. Therefore, demographic information about users can be stored in profile database 110 as part of corresponding user profiles. For another example, a website or web portal may track a user's navigation throughout the site or portal, e.g., record what web pages the user viewed and for how long, how the user uses other services such as e-mail, instant messaging, calendar, and search services, what other ads the user interacted with, and the like. For another example, a search engine website may record a user's search behavior, i.e., record what keywords the user searched for. Therefore, information about users' interests and web surfing behavior (e.g., historical behavior and/or recent behavior) can be stored in profile database 110 as part of corresponding user profiles. Hence, according to an embodiment, a user's personal profile comprises information about the user other than the user's interactions with the rich media 104.

According to an embodiment, user behavior correlator 108 stores information regarding the interaction of user 102 with rich media 104 in association with the user's personal profile stored in profile database 110. For example, behavior correlator 108 ties the user-level cookie information that is sent to a server as the user browses the website, and which may be stored in profile database 110, with the rich media interaction cookie information. User behavior correlator 108 is capable of formulating and submitting queries to profile database 110 in order to extract various combinations of data items stored as user profiles, for a given user or for groups of users.

Market Segmentation

Target Marketing involves breaking a market into segments, a process also referred to as market targeting and market segmentation, and then concentrating marketing efforts on one or more key segments. Often, this market segmentation is based on one or more of (a) geographic segmentation based on location, such as home addresses; (b) demographic segmentation based on measurable statistics, such as age or income; and (c) psychographic segmentation based on lifestyle preferences, such as being urban dwellers, pet lovers, travelers, food enthusiasts, sports enthusiasts, consumer electronic enthusiasts, music or movie enthusiasts, and the like.

According to an embodiment, user behavior correlator 108 outputs market segmentation information 112, where market segmentation information 112 comprises information about one or more users that can be analyzed and used for construction of target markets, such as information representing the user's specific interaction with rich media 104 in association with data from the user's personal profile. For example, market segmentation information 112 may be used to group a particular user into a particular target market, for example, a target market group of males over 50 years old with incomes greater than $120,000 who chose to play an animated golf game in rich media 104 and moused over a rich media 104 panel regarding a golf club giveaway promotion; or a target market group of males and females from 21-31 years old living in non-coastal areas with incomes over $80,000 who moused over a rich media 104 panel regarding a credit card promotion and who visited web pages relating to travel. The foregoing are simply non-limiting examples of target market groups in which users of a web portal may be grouped, to portray the concept that various combinations of user rich media interaction information and personal profile information can be used to place users in various behavioral target market groups for marketing purposes. Each target market group may itself be a target market, or multiple target market groups may be combined to form a target market. Furthermore, the techniques described herein provide immediate results in that users' interactions with rich media can be collected and tied in with users' personal profiles in real-time, rather than needing to wait for an advertising campaign to complete before analyzing the impact of the campaign.

Based on the techniques described herein, the segment of potential consumers that respond to a rich media 104 advertisement can be remarketed to. Returning to a previous example, a banking advertiser may display a credit card offer, a brokerage product, and a mortgage product in the same rich media advertisement. Thus, identifying users that moused over the credit card offer allows for targeting those same users in the future. Furthermore, learning more about users that respond to rich media 104 advertisements is also useful to advertisers, behavioral models, and behavioral targeting systems, where the information about users' interactions with the rich media 104 can be tied to all other information a popular web portal (e.g., Yahoo!) has about those users, e.g., demographic and geographic information, clickstream data, search data, and other ad view and ad click activity. Such correlated user information can, for example, be used for future marketing campaigns.

### A Method for Rich Media Engagement Based Market Segmentation

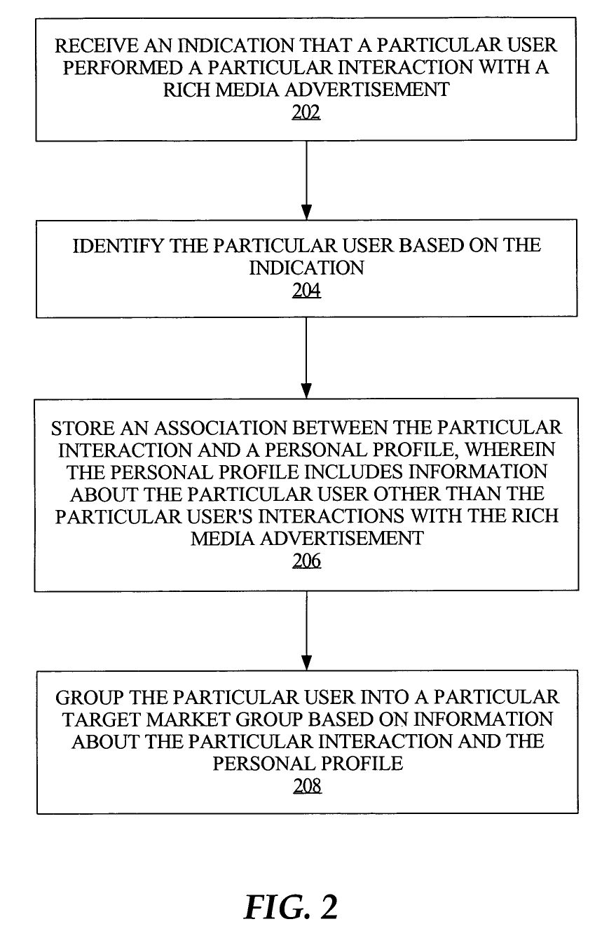

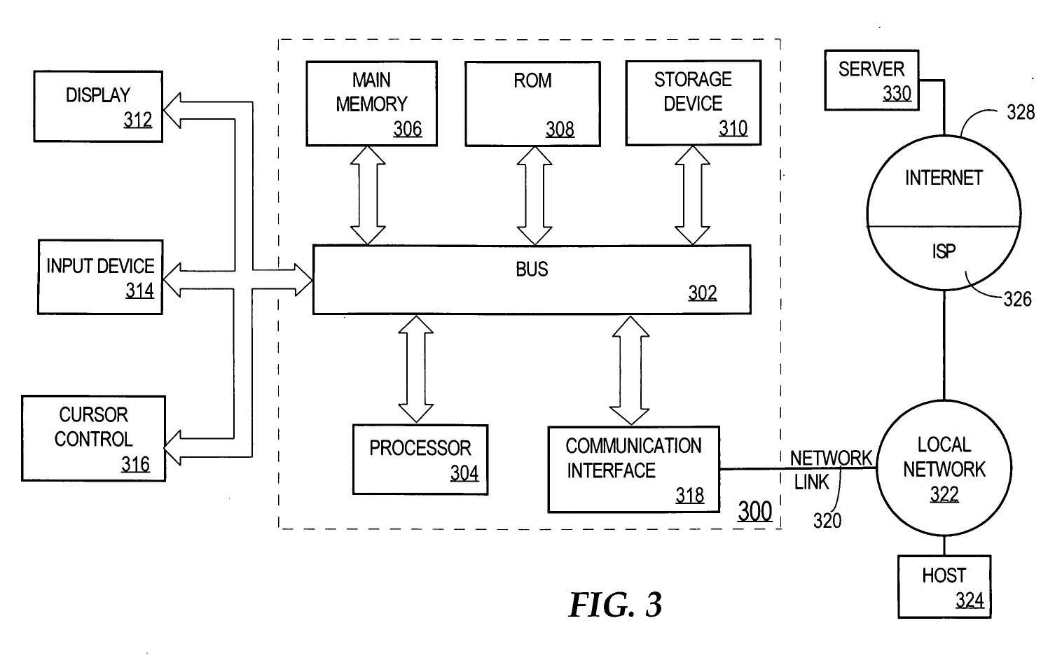

FIG. 2 is a flow diagram that illustrates a method for rich media engagement based market segmentation, according to an embodiment of the invention. The method depicted in FIG. 2 is a computer and/or machine-implemented method in which a computer or machine performs the method, such as by one or more processors executing instructions. For example, the method may be performed on or by a computer system such as computer system 300 of FIG. 3.

At block 202, an indication is received that a particular user performed a particular interaction with a rich media advertisement. For example, beacon server 106 (FIG. 1) receives a request for the beacon-associated graphic image from a browser executing on user device 103 (FIG. 1), in response to user 102 (FIG. 1) interacting with the rich media 104 (FIG. 1) displayed in web page 105 (FIG. 1). This indication is not a general indication that a user interacted with the rich media ad, but an indication of what type of action was performed and with which particular part of the ad the user interacted. For example, different parts of the rich media ad may be instrumented with independent beacons which, when executed, trigger transmission of a corresponding request and a cookie to a server from the browser, where each request that corresponds to a respective beacon is different and identifies the part of the rich media ad with which it is associated. Hence, based on the particular request from the browser based on the particular beacon, the receiving server is able to determine what specific part of the ad the user interacted with and how the user interacted with that part of the ad. For example, when the user mouses over a second of four panels of the rich media 104, beacon code causes the browser to send a particular request which identifies the second panel and the mouseover action, with a cookie which identifies the user, to beacon server 106. On the other hand, if the user clicked on the second panel rather than moused over the second panel, thereby triggering a request for a web page that is linked to that second panel, then the browser sends the cookie with the request to the web server serving the web page, as is typical for monitoring click-throughs.

At block 204, the particular user is identified based on the indication received at block 202. If the user has signed in to a personal account associated with the web page in which the rich media 104 is contained, then the cookie identifies the user by the user's account ID. This type of cookie that is associated with a logged in profile is referred to as an L-cookie (e.g., a “logged in cookie”). Identifying the particular user provides for looking up relatively long-term personal profile information about the user, for example, from profile database 110 (FIG. 1). However, if the user has not signed into a personal account, then the cookie may uniquely identify the user by the IP address of user device 103. This type of cookie that is not associated with a logged in profile is referred to as a B-cookie (i.e., a “browser cookie”). Thus, if the user is not signed in to a personal account, then the user might not be able to be immediately and specifically identified and, therefore, associated with long-term personal profile information. B-cookies provide near-term personal profile information regarding the user's web navigation for a period of time. However, B-cookies represent a much shorter timeframe and have a shorter lifetime because B-cookies are often deleted after some period of time, e.g., a few weeks, a month, a few months, depending on the user. Regardless, the anonymous user's rich media interactions for a given session may still be monitored and recorded for its inherent value regarding the particular rich media advertisement, and in anticipation of the anonymous user providing identification information later during the session.

As mentioned, a rich media 104 (FIG. 1) advertisement can be instrumented for tracking user interactions in a comprehensive manner, whereby multiple different aspects of the rich media 104 are separately instrumented for sending user identification information (e.g., a cookie) and rich media interaction information to a server in response to a user interacting with an aspect of the rich media 104. For example, the “Play”, “Pause”, and “Stop” buttons for a video presentation may be independently instrumented to notify beacon server 106 (FIG. 6) of a user interaction with that corresponding button. From such user interactions with rich media 104, other related metrics may be computed. Non-limiting examples of metrics that may be computed include the amount of time that the user viewed the video before stopping or pausing, whether the user unpaused the video after pausing it and how much time elapsed in between pause and unpause, how many times the user viewed the video, and the like.

An advertiser or other party might be additionally interested in what a user does external to the user's interactions with rich media. At block 206, an association between the particular interaction with the rich media 104 (FIG. 1) advertisement and a personal profile is stored, where the personal profile includes information about the user other than the user's interaction with the rich media 104. For example, in response to receiving the rich media user interaction information and the user identification information from beacon server 106 (FIG. 1), user behavior correlator 108 (FIG. 1) accesses profile database 110 (FIG. 1) to access the user's personal profile, where the personal profile includes, for example, information about the user's demographics and personal interests and/or the user's historical and/or recent web surfing patterns or behavior. For example, associating a user's web surfing behavior between interactions with a rich media advertisement could provide valuable insight for behavioral modeling and market targeting purposes. For example, the fact that a user paused a travel-related video, then navigated to a travel vertical site followed by a weather site followed by a clothing retail site, and then returned to view the remainder of the video, could be useful information for grouping the user into a group of potential purchasers of travel-related goods and services as well as of clothes for traveling. In storing an association between the rich media user interaction information and the user profile, the user's rich media interaction information may be integrated into or linked to the user's personal profile, such as in profile database 110.

According to an embodiment, user behavior correlator 108 performs some statistical analysis on the rich media user interaction information and the user's personal profile information, or otherwise correlates such information, to generate market segmentation information 112 (FIG. 1). Such market segmentation information 112 may vary from implementation to implementation. For example, market segmentation information 112 may comprise one or more recommendations about marketing to the particular user 102 (FIG. 1) who interacted with the rich media 104 (FIG. 1), such as what types of products the user might be interested in purchasing. For another example, market segmentation information may comprise information about further use of the particular rich media 104 advertisement for marketing purposes based on, for example, an aggregate of information about multiple users' particular interactions with the rich media 104 advertisement in association with the users' corresponding personal profiles. Information regarding further use of the rich media advertisement may comprise, for non-limiting examples, whether or not different aspects of the advertisement might be successful for a given marketing campaign, as well as advisories to change the advertisement, re-serve the advertisement to the same group, narrow service of the advertisement to another group or expand service to another group or groups, and the like.

According to one embodiment, at block 208, the particular user is grouped into a particular target market group based at least in part on information about the user's particular interaction with the rich media and the user's personal profile. For example, market segmentation information 112 could be fed into, or be the result of, behavioral modeling. Behavioral modeling can provide the framework for transforming data into information that can be used to predict customer behavior, generally, by determining which products/services each customer is most interested in. Response modeling uses historical data to develop profiles of buyers and non-buyers for each product/service, whereas retention modeling can identify trigger points for customer attrition. Furthermore, market segmentation information 112 could be fed into, or be the result of, behavior targeting systems which, generally, place advertising messages in the path of the user based on the user's past behavior rather than placing advertising messages against content the advertiser assumes the user will be interested in.

Grouping the particular user into a particular target market group, at block 208, may be performed by the same party that received the rich media user interaction indication and stored such information in association with the user's personal profile. Alternatively, the rich media user interaction information in association with the personal profile information could be passed to a different party for use in placing the particular user in a target market group. Regardless of who performs the grouping process, important information that is useful for behavioral market targeting is generated and compiled without having to follow the user to websites from links within rich media advertisements. Hence, advertisers that want to learn about and target consumers that show various levels of interaction with rich media advertisement units are provided with useful behavioral information for market targeting purposes.

### Hardware Overview

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT) or liquid crystal display (LCD), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to an embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic or magneto-optical disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be a digital subscriber line (DSL), cable, or integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

### Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Alternative embodiments of the invention are described throughout the foregoing specification, and in locations that best facilitate understanding the context of the embodiments. Furthermore, the invention has been described with reference to specific embodiments thereof. It will, however, be evident that various modifications and changes may be made thereto without departing from the broader spirit and scope of the invention.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A method comprising performing a machine-executed operation involving instructions, wherein said instructions are instructions which, when executed by one or more processors, cause the one or more processors to perform certain steps comprising:
receiving an indication that a particular user performed a particular interaction with a rich media advertisement;
identifying said particular user based on said indication; and
storing an association between said particular interaction and a personal profile corresponding to said particular user, wherein said personal profile includes information about said particular user other than said particular user's interactions with said rich media advertisement;
wherein the machine-executed operation is at least one of (a) sending said instructions over transmission media, (b) receiving said instructions over transmission media, (c) storing said instructions onto a machine-readable storage medium, and (d) executing the instructions.

2. The method of claim 1, said certain steps comprising:
grouping said particular user into a particular target market group based at least in part on information about said particular interaction and said personal profile.

3. The method of claim 1, wherein receiving comprises receiving at a server a request that includes a cookie that identifies said particular user.

4. The method of claim 3, wherein receiving comprises receiving said request which is triggered by said particular interaction with said rich media advertisement.

5. The method of claim 4, wherein receiving comprises receiving an indication that said particular user located a cursor over said rich media advertisement.

6. The method of claim 3, wherein a website in which said rich media advertisement is contained is served by a first party and wherein said rich media advertisement is served by a second party that is different from said first party.

7. The method of claim 3, wherein said rich media advertisement and a website in which said rich media advertisement is contained are both served by the same party.

8. The method of claim 1, wherein said personal profile includes information about said particular user's behavior within a network domain in which said rich media advertisement is displayed to said particular user.

9. The method of claim 8, wherein said personal profile includes information about said particular user's historical behavior involving a search engine associated with said network domain.

10. The method of claim 1, wherein said personal profile includes demographic information about said particular user.

11. The method of claim 1, wherein receiving comprises receiving an indication that said particular user performed a particular interaction with a particular frame of a plurality of frames of said rich media advertisement.

12. The method of claim 1, said certain steps comprising:
based at least in part on said particular interaction and said personal profile, providing, to a party who is advertising via said rich media advertisement, a recommendation regarding marketing to said particular user.

13. The method of claim 1, wherein receiving comprises receiving a plurality of indications of particular interactions with said rich media advertisement involving a plurality of users, and wherein each particular user from said plurality of users is associated with a corresponding user profile, said certain steps comprising:
based at least in part on said particular interactions and said personal profiles, providing, to a party who is advertising via said rich media advertisement, information regarding further use of said rich media advertisement for marketing purposes.

14. The method of claim 1, wherein receiving comprises receiving an indication that said particular user located a cursor over said rich media advertisement.

15. The method of claim 14, wherein receiving comprises receiving an indication that said particular user located a cursor over a particular frame of a plurality of frames of said rich media advertisement.

16. The method of claim 1, wherein receiving comprises receiving an indication that said particular user selected with a cursor control device a particular frame of a plurality of frames of said rich media advertisement.

17. The method of claim 1, wherein receiving comprises receiving an indication that said particular user selected to play a video associated with said rich media advertisement.

18. The method of claim 1, wherein receiving comprises receiving an indication that said particular user selected to stop playing a video associated with said rich media advertisement.

19. The method of claim 18, wherein receiving comprises receiving an indication of how much time passed between said particular user selecting to play said video and selecting to stop playing said video.

20. The method of claim 1, wherein receiving comprises receiving an indication that said particular user selected to pause playing of a video associated with said rich media advertisement.

21. The method of claim 20, wherein receiving comprises receiving an indication of how much time passed between said particular user selecting to play said video and selecting to pause playing said video.

22. The method of claim 1, wherein receiving comprises receiving an indication that said particular user allowed an entire video associated with said rich media advertisement to play.
